(19) United States
(12) Patent Application Publication
(10) Pub. No.: US 2025/0340416 A1
(43) Pub. Date: Nov. 6, 2025

(54) PATH SPECIFICATION SYSTEM, PATH SPECIFICATION APPARATUS, AND PATH SPECIFICATION METHOD

(71) Applicant: NEC Corporation, Minato-ku, Tokyo (JP)

(72) Inventors: Ryutaro YAMAGUCHI, Tokyo (JP); Takahiro SHIROSHIMA, Tokyo (JP)

(73) Assignee: NEC Corporation, Minato-ku, Tokyo (JP)

(21) Appl. No.: 18/871,205

(22) PCT Filed: Jun. 30, 2022
(86) PCT No.: PCT/JP2022/026219

§ 371 Date: Dec. 3, 2024

(51) Int. Cl. B66F 9/075; B66F 9/06; G05D 1/246; G05D 1/622; G05D 1/667; G05D 105/20; G05D 107/70; G05D 109/10

(52) U.S. Cl. CPC B66F 9/0755; B66F 9/063; G05D 1/246; G05D 1/622; G05D 1/667; G05D 2105/20; G05D 2107/70; G05D 2109/10

(57) ABSTRACT

A path specification system or a path specification apparatus capable of improving a safety level and efficiency in a system in which a mobile body on which an object is loaded conveys the object to a place where the object is unloaded is provided. The path specification system or the path specification apparatus acquires information on a center of gravity of an object loaded on a mobile body. The path specification system or the path specification apparatus specifies a path to the place where the object is unloaded in accordance with safety in conveying the object in the mobile body determined based on a control value for controlling the mobile body and information on the center of gravity of the object.

### TECHNICAL FIELD

The present disclosure relates to a path specification system, a path specification apparatus, and a path specification method.

### BACKGROUND ART

Techniques regarding control in a case where a mobile body conveys articles have been studied.

For example, Patent Literature 1 discloses a forklift apparatus intended to quickly convey a load. The forklift apparatus disclosed in Patent Literature 1 includes an error prediction unit, a travel route correction unit, and a conveyance travel control unit. The error prediction unit predicts a first positional error which is a positional error after picking-up between a standard position of a fork and a central position of a pallet on the fork after the pallet is picked up and a first angle error which is an angle error after picking-up with respect to the fork in the pallet. The travel route correction unit corrects a travel route from a picking-up position of the pallet to a stacking position of the pallet to offset the first positional error and the first angle error in a case where the pallet is stacked. The conveyance travel control unit performs travel control such that the pallet is conveyed along the corrected travel route.

As described above, Patent Literature 1 discloses the invention of correcting a route from the picking-up position of the pallet to the stacking position of the pallet so as to offset the angle error and the positional error between the pallet and the fork after the forklift has acquired the pallet.

Further, Patent Literature 2 discloses a center-of-gravity estimation apparatus intended to estimate, in a state in which a cargo is loaded on a loading portion of a loading or unloading vehicle, a center-of-gravity position of the cargo in a plurality of directions of the loading or unloading vehicle. The center-of-gravity estimation apparatus disclosed in Patent Literature 2 includes two load sensors that detect respective loads applied to two right and left front wheels, and a pressure sensor that detects a pressure of a lift cylinder. The center-of-gravity estimation apparatus calculates a center-of-gravity estimation value of the cargo in the front-back direction of the forklift based on the loads applied to the two right and left front wheels detected by the two load sensors, a pressure of the lift cylinder detected by the pressure sensor, and data regarding the structure of the forklift. The center-of-gravity estimation apparatus calculates a center-of-gravity estimation value of a cargo in the transverse direction of the forklift based on the loads applied to the two right and left front wheels detected by the two load sensors and the data regarding the structure of the forklift.

As described above, Patent Literature 2 discloses the invention in which the center-of-gravity position of the cargo is estimated from the load applied to the front wheel and the pressure of the lift cylinder. Patent Literature 2 further discloses limiting acceleration, deceleration, and a turning speed in a case where the center-of-gravity position of the cargo is close to the acceptable value of the center of gravity.

### CITATION LIST

### Patent Literature

[Patent Literature 1] Japanese Unexamined Patent Application Publication No. 2020-001906
[Patent Literature 2] Japanese Unexamined Patent Application Publication No. 2020-111403

### SUMMARY OF INVENTION

### Technical Problem

However, in the technique disclosed in Patent Literature 1, depending on a route after it is corrected so as to offset the angle error and the positional error between the pallet and the fork, the safety level may be reduced due to a force applied to the pallet or to the mobile body.

Further, in the technique disclosed in Patent Literature 2, if the turning speed is restricted every time the center-of-gravity position of the cargo comes close to or exceeds the acceptable value of the center of gravity, it is possible that articles cannot be efficiently conveyed.

In view of the above circumstances, an object of the present disclosure is to improve a safety level and efficiency in a system in which a mobile body on which an object is loaded conveys the object to a place where the object is unloaded.

### Solution to Problem

In order to achieve the above object, a path specification system according to the present disclosure includes: a first acquisition means for acquiring information on a center of gravity of an object loaded on a mobile body; and specification means for specifying a path to a place where the object is unloaded in accordance with a safety level in conveying the object in the mobile body determined based on a control value for controlling the mobile body and information on the center of gravity of the object.

A path specification apparatus according to the present disclosure includes: a first acquisition means for acquiring information on a center of gravity of an object loaded on a mobile body; and specification means for specifying a path to a place where the object is unloaded in accordance with a safety level in conveying the object in the mobile body determined based on a control value for controlling the mobile body and information on the center of gravity of the object.

A path specification method according to the present disclosure includes: acquiring information on a center of gravity of an object loaded on a mobile body; and specifying a path to a place where the object is unloaded in accordance with a safety level in conveying the object in the mobile body determined based on a control value for controlling the mobile body and information on the center of gravity of the object.

### Advantageous Effects of Invention

According to the present disclosure, it is possible to improve a safety level and efficiency in a system in which a mobile body on which an object is loaded conveys the object to a place where the object is unloaded.

### BRIEF DESCRIPTION OF DRAWINGS

FIG. 1 is a block diagram illustrating a configuration example of a path specification system according to a first example embodiment;

FIG. 2 is a block diagram illustrating a path specification apparatus, which is a configuration example of the path specification system of FIG. 1;

FIG. 3 is a flowchart for describing an example of a path specification method in the path specification system of FIG. 1 or the path specification apparatus of FIG. 2;

FIG. 4 is a block diagram illustrating a detailed configuration example of the path specification system of FIG. 1;

FIG. 5 is a side view schematically illustrating one example of a forklift that travels along a path specified in the path specification system of FIG. 4;

FIG. 6 is a flowchart for describing an example of path specification processing in a remote control apparatus in the path specification system of FIG. 4;

FIG. 7 is a schematic diagram illustrating one example of a path calculated in the path specification processing of FIG. 6;

FIG. 8 is a schematic diagram for describing safety level determination processing in the path specification processing of FIG. 6;

FIG. 9 is a schematic diagram illustrating one example of a state in which an obstacle is avoided on the path calculated in the path specification processing of FIG. 6;

FIG. 10 is a flowchart for describing an example of path specification processing in a path specification system according to a second example embodiment;

FIG. 11 is a block diagram illustrating a configuration example of a path specification system according to a third example embodiment; and

FIG. 12 is a block diagram illustrating a configuration example of an apparatus.

### EXAMPLE EMBODIMENT

Hereinafter, example embodiments of the present disclosure will be described in detail with reference to the drawings. Note that the following descriptions and the drawings are omitted and simplified as appropriate for the sake of clarification of the description. Throughout the drawings, the same symbols are attached to the same and similar elements and overlapping descriptions are omitted as necessary.

### First Example Embodiment

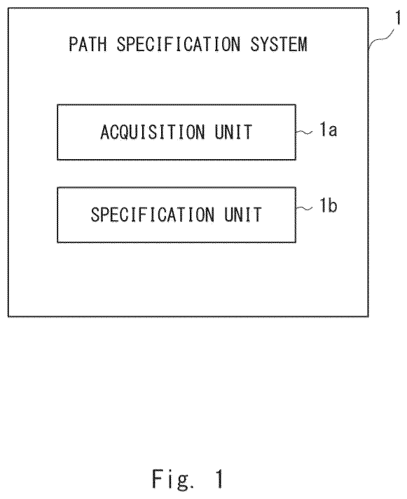

With reference to FIGS. 1-9, a first example embodiment will be described. First, with reference to FIGS. 1-3, configurations and processing in the present example embodiment will be described. FIG. 1 is a block diagram illustrating a configuration example of a path specification system according to the present example embodiment.

A path specification system 1 according to the present example embodiment illustrated in FIG. 1 is a system that specifies a path of a mobile body such as a lift apparatus like a forklift. Further, the path specification system 1 may also be constructed as a system including a movement control unit (not shown) that controls a movement of a mobile body such as a forklift, or a system including a movement control unit and a mobile body. Further, the path specification system 1 may also be constructed as a system including a motion control unit (not shown) that controls a motion other than the movement in the mobile body, such as a motion of a fork of the forklift.

The path specified in the path specification system 1 is a path to a place where an object is unloaded, and a departure point may be a place where the above object is loaded. However, the path is not limited to this, and may be any position of the mobile body.

Hereinafter, an autonomously movable forklift will be mainly described as a mobile body as an example, but the mobile body is not limited thereto, and various other types of autonomously movable mobile bodies capable of carrying or conveying an object to a place where the object is unloaded may be used instead. Further, the mobile body may be a mobile body that does not have an autonomous movement function. In this case, it is possible to guide a driver by causing the specified path to be displayed on a display apparatus or the like of a driver's seat.

Further, the object may refer to something such as a cargo that is conveyed by the mobile body. In a case where the mobile body is a forklift, the object to be conveyed may refer to a cargo loading pallet and the cargo loaded thereon. The cargo loading pallet may include a frame that forms a space for inserting the fork from a horizontal direction. Note that the object to be conveyed without using the cargo loading pallet is the cargo itself.

As illustrated in FIG. 1, the path specification system 1 according to the present example embodiment may include an acquisition unit 1a, which is an example of first acquisition means, and a specification unit 1b, which is an example of specification means. In the path specification system 1, the acquisition unit 1a and the specification unit 1b may be mounted in a plurality of apparatuses in a distributed manner, and any distribution method thereof is applicable. For example, the path specification system 1 may include an apparatus including the acquisition unit 1a, and an apparatus including the specification unit 1b. Each apparatus may include a computer apparatus including hardware including, for example, one or more processors and one or more memories. Then, at least some of functions of the units mounted in each apparatus may be implemented in such a way that one or more processors operate in accordance with a program read from one or more memories. In addition, some of the functions that may be provided on the path specification system 1 may also be provided in a cloud server or the like.

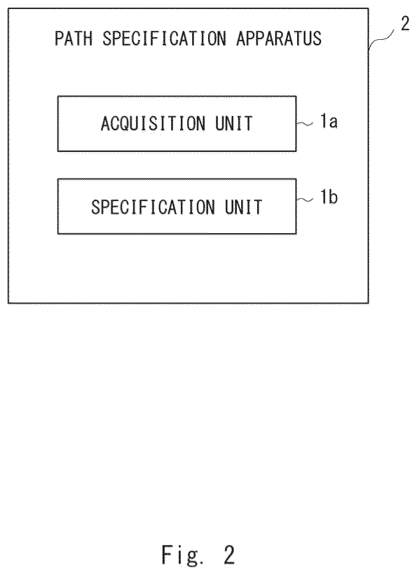

In addition, as illustrated in FIG. 2, the path specification system 1 may also be constructed as one path specification apparatus 2 including the acquisition unit 1a and the specification unit 1b. FIG. 2 is a block diagram illustrating the path specification apparatus 2, which is one configuration example of the path specification system 1 illustrated in FIG. 1. The path specification apparatus 2 may be configured to include a computer apparatus including hardware including, for example, one or more processors and one or more memories. At least some of functions of the units in the path specification apparatus 2 may be implemented by one or more processors operating in accordance with a program read from one or more memories. Note that the path specification apparatus 2 may be implemented in such a way that the functions of the respective units are distributed to separate apparatuses, and a distribution method thereof is not limited. For example, the path specification apparatus 2 may include an apparatus including the acquisition unit 1a and an apparatus including the specification unit 1b.

Next, the acquisition unit 1a and the specification unit 1b will be described.

The acquisition unit 1a acquires information on a center of gravity of an object loaded on a forklift (hereinafter this information will be referred to as “object's center-of-gravity information”). The object's center-of-gravity information is information on the center of gravity used to determine a safety level of conveyance, and may be, for example, information on the shape of the object and coordinates of a center-of-gravity position of the object. Further, the object's center-of-gravity information may include information on the weight of the object. The object's center-of-gravity information may be acquired by any route or any method.

The acquisition unit 1a may receive, for example, object's center-of-gravity information measured by a center-of-gravity measurement equipment before the object is loaded on the forklift. Alternatively, the acquisition unit 1a may receive the shape and the weight of the object obtained before the object is loaded on the forklift and calculate object's center-of-gravity information from the received information items, or receive object's center-of-gravity information, which is a result of the calculation. In a case where the shape and the weight of the object are received, the object's center-of-gravity information may be calculated, for example, from the shape and the weight assuming that the density of the object is uniform.

The weight of the object may be measured by equipment that measures the weight before the object is loaded on the forklift. Further, the shape of the object may be obtained from a result of capturing an image thereof by, for example, a laser sensor such as LiDAR (registered trademark), an infrared time-of-flight (ToF) camera, a 3D camera, or the like, before the object is loaded on the forklift. Note that the shape of the object may be measured from the whole surface thereof, or may be measured from an oblique direction of the object and the shape of a non-measured surface may be estimated from the result of the measurement of the oblique direction of the object. A timing before the object is loaded on the forklift may be any timing before it is loaded on the forklift. For example, in a case where the object is a parcel to be delivered, the above timing may be the timing of acceptance of a request for delivery of the parcel.

Alternatively, the acquisition unit 1a may receive, from the forklift, a result of detecting a distribution of the weight by a sensor sheet provided in the forklift, and calculate the object's center-of-gravity information based on the result. Here, the distribution of the weight may refer to a distribution of a surface pressure. Alternatively, the forklift may detect the distribution of the weight by the sensor sheet provided in the forklift and perform processing for calculating the object's center-of-gravity information based on the detected result, and the acquisition unit 1a may receive the object's center-of-gravity information calculated on the side of the forklift from the forklift.

The above sensor sheet may be provided in a loading unit on which the object is loaded. Here, loading an object may refer to applying a load to the object, such as loading the object, gripping and lifting the object on the lower side of a projection portion or the like of the object, or hanging and lifting the object by hooking a hanging tool on a part of the object. The loading unit refers to a place where the load is applied. In a case of a forklift, loading an object on the fork refers to loading the object on the fork, and the loading unit refers to a fork. The loading unit may be, for example, a carrying portion (i.e., loading portion) on which an object is carried (i.e., loaded), a support portion that supports the object at a plurality of points, or the like, and may also be referred to as a laden portion. The loading unit is a portion for lifting an object.

Alternatively, the acquisition unit 1a may receive the shape of the object obtained from the result of capturing an image of the object by a camera or the like and the result of detecting the weight by a weight sensor provided in the forklift, and then calculate object's center-of-gravity information based on these results. This weight sensor may be provided in the loading unit on which the object is loaded and may be, for example, a sensor that detects a load amount of the loading unit in the forklift. However, it is sufficient that the weight sensor be installed in a position where it is possible to measure the load amount on the loading unit, which is applied due to the object being loaded and obtain the measurement result, or in a position where it is possible to obtain the measurement result. The weight sensor may be, for example, a sensor that calculates the load amount related to the fork from the pressure of a hydraulic cylinder that controls lifting or lowering of the fork. As in this example, the load amount of the loading unit may also be detected at another position connected to the loading unit.

The specification unit 1b specifies a path to the place where the object is unloaded in accordance with a safety level in conveying an object in a forklift. The path indicates a path along which the forklift travels. The safety level in conveying the object in the forklift may indicate a damage to each of the forklift and the object and a possibility that the object may fall. In a case where, for example, there is a high possibility that an object may fall or a forklift may overturn, it is considered that the safety level is low.

The safety level in conveying the object in the forklift is determined based on control values for controlling the forklift and the object's center-of-gravity information. The specification unit 1b may calculate information on the safety level and specify a path in accordance with this information, or receive information on the safety level externally calculated and specify a path in accordance with this information. However, these are merely examples, and the specification unit 1b may receive, for example, control values and object's center-of-gravity information and specify a path in such a way that the safety level is taken into consideration based on the control values and the object's center-of-gravity information that have been input.

The above control values refer to control values for moving the forklift, and will be hereinafter called movement control values. The movement control values may refer to, for example, a control value of an accelerator, a control value of a brake, a control value of a steering wheel, and so on. The steering wheel may be referred to as a steering wheel. However, in some kind of autonomously movable mobile bodies such as an autonomously movable forklift, a steering wheel may not be provided. Regardless of whether a mobile body includes a steering wheel, the control value of the steering wheel described above may refer to an angle value indicating a steering angle of a target to be driven such as a wheel. Since the steering angle corresponds to a turning angle, the control value of the steering wheel may be a turning angle value. Further, the control value of the steering wheel may include a control value indicating a turning radius.

The movement control values may be an acceleration or deceleration value indicating acceleration or deceleration of the forklift in place of the control value of the accelerator and the control value of the brake. Alternatively, as the movement control values, a speed value may be used in place of the acceleration or deceleration value, in which case acceleration or deceleration is applied in accordance with this speed value.

Further, the path specification system 1 or the path specification apparatus 2 may include a movement control unit (not shown), as described above. Alternatively, the path specification system 1 or the path specification apparatus 2 may be connected to the movement control unit. This movement control unit controls the forklift in such a way that the forklift travels along the path specified by the specification unit 1b. Then, some or all of the values that control movement of the forklift by the movement control unit may be acquired by the specification unit 1b as the above movement control values.

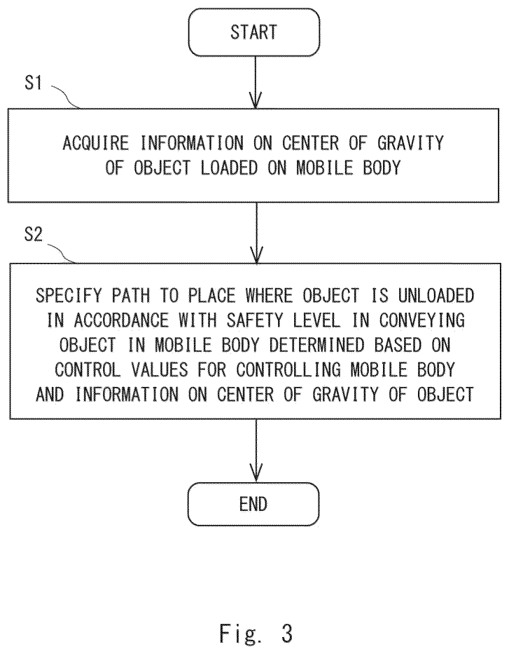

Next, with reference to FIG. 3, a path specification method in the path specification system 1 or the path specification apparatus 2 having the above-described configuration will be described. FIG. 3 is a flowchart for describing an example of the path specification method.

In this path specification method, the acquisition unit 1a acquires information on the center of gravity of the object loaded on a mobile body such as a forklift (Step S1). Next, the specification unit 1b specifies a path to a place where the object is unloaded in accordance with a safety level in conveying the object in the mobile body determined based on the control values for controlling the mobile body and the object's center-of-gravity information (Step S2). Accordingly, the processing for specifying the path is ended. After that, the mobile body such as a forklift is made to travel along the specified path.

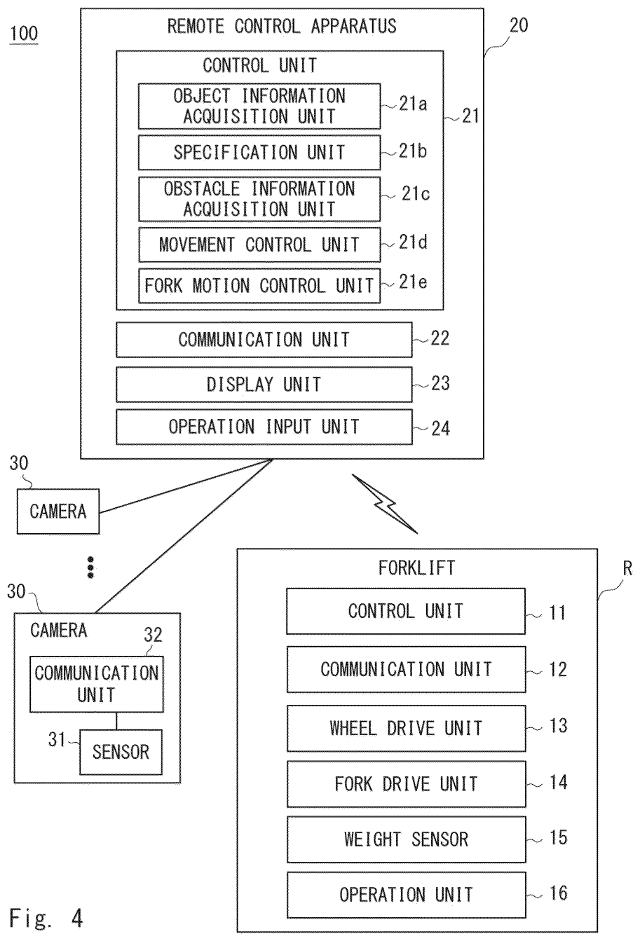

While detailed examples of the acquisition processing for acquiring information on a center of gravity and the specification processing for specifying a path will be described with reference to FIGS. 4-9, the following effects are achieved by performing the above processing in the present example embodiment. That is, in the present example embodiment, by calculating, for example, a path from a place or the like where an object is loaded to a place where the object is unloaded in accordance with a safety level determined based on the movement control values and the object's center-of-gravity information, a safe and efficient path may be calculated. Here, the reason why the safe and efficient path may be obtained will be understood more clearly by considering a case where a mobile body needs to make turns or accelerate or decelerate at a plurality of places. That is, in the present example embodiment, the path may be specified as a result of properly correcting or calculating the travel path at each turning place and a place where each acceleration or deceleration is performed in such a way that the safety level determined based on the movement control values and the object's center-of-gravity information is ensured. As a result, the specified path may be an efficient path while the safety level is ensured for the entire path, and the specified path may be a path with improved safety level and efficiency compared to a comparative example where the present example embodiment or second and third example embodiments that will be described later is not employed.

Here, the efficient path may refer to, for example, a path which enables the mobile body to move to the place where the object is unloaded in the shortest time. However, the efficient path may also refer to, for example, but not limited to, a path which enables the mobile body to move to the place where the object is unloaded with minimum power or in the shortest distance. Except for the safety level, any known technique may be applied to determine under what conditions the path will be generated and adopted.

As described above, according to the present example embodiment, it becomes possible to specify a path with improved safety level and efficiency in a case where a mobile body on which an object is loaded conveys the object to a place where the object is unloaded.

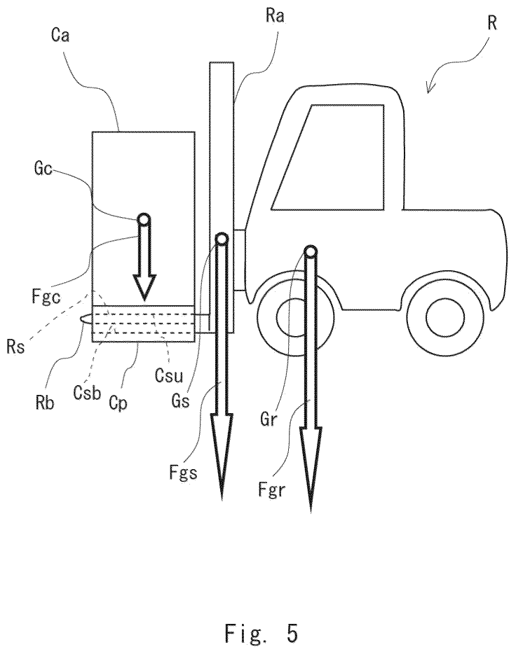

Next, with reference to FIGS. 4 to 9, a detailed configuration example of the path specification system 1 of FIG. 1 will be described. First, with reference to FIGS. 4 and 5, an outline of the configuration example will be described. FIG. 4 is a block diagram illustrating a detailed configuration example of the path specification system 1 of FIG. 1. FIG. 5 is a side view schematically illustrating an example of a forklift that travels along a path specified by the path specification system of FIG. 4.

A path specification system 100 illustrated in FIG. 4 may include one or a plurality of forklifts R, a remote control apparatus 20, which is an example of the path specification apparatus 1, and one or a plurality of ToF cameras (hereinafter simply a camera) 30.

The camera 30 is connected to the remote control apparatus 20 in a wired or wireless manner. The camera 30 may be installed at one or more locations, such as a ceiling where the height of the object is measurable. The camera 30 is one example of a sensor that is provided to measure the shape of the object.

The camera 30 may include a sensor 31 such as a light receiving element, and a communication unit 32 that transmits sensor information detected by the sensor 31 or distance information calculated therefrom to the remote control apparatus 20 as shape information which indicates the shape. While the shape information may be transmitted to the remote control apparatus 20 as information from which information on the background such as the ground is excluded, this exclusion may be performed in the remote control apparatus 20. Note that, in place of the camera 30, a sensor other than the ToF camera may be employed.

The camera 30 may acquire, as the shape information, not only information on the shape of the object, but also information on the shape of an obstacle that is present in an area that may be specified as a path, and transmit the acquired information to the remote control apparatus 20 via the communication unit 32. In order to acquire the information on the shape of the object, a camera 30 installed in an upper front part of the forklift R may be, for example, used. In order to acquire information on the shape of the obstacle, a camera 30 installed above each obstacle may be, for example, used. However, since it may not be clear where the obstacle is located, the path specification system 100 may acquire information on the shape of each of obstacles from one or more of all the cameras 30 installed throughout the area in which the forklift R may move.

In addition, one or a plurality of forklifts R are wirelessly connected to the remote control apparatus 20 as a control target. Hereinafter, one forklift R will be described as a control target, but other forklifts may be similarly controlled.

The forklift R may include a control unit 11 that controls the entire forklift R, a communication unit 12 that performs wireless communication with the remote control apparatus 20, a wheel drive unit 13 that drives a wheel, a fork drive unit 14 that drives a fork, a weight sensor 15, and an operation unit 16. The control unit 11 may be configured to include a computer apparatus including hardware including, for example, one or more processors and one or more memories. Then, at least some of functions of the units mounted in the forklift R may be implemented in such a way that one or more processors operate in accordance with a program read from one or more memories. Note that the communication unit 12 may also be configured to be directly wirelessly connected to the camera 30.

As illustrated in FIG. 5, the forklift R may include, on the front side of the main body, a lift portion Ra which is a part of the fork drive unit 14, and a fork Rb which is attached so as to be movable up and down by the lift portion Ra. The lift portion Ra may be configured by, for example, a lift cylinder, a lift chain, or the like, but various existing mechanisms may be applied. Other portions of the fork drive unit 14, for example, a motor that provides power for lifting or lowering the fork Rb with respect to the lift portion Ra, a driving source such as an engine, and the like may be provided on the main body side of the forklift R. In FIG. 5, the fork Rb has a loading surface Rs serving as a surface on which a cargo loading pallet Cp, which is a part of the object, is loaded, and the weight sensor 15 may be installed on the loading surface Rs. While an example in which the cargo loading pallet Cp performs calculations of a center of gravity and so on as a part of the object will be described in order to simplify the description, a configuration in which calculations of a center of gravity and so on are performed as a part of the forklift R may instead be employed.

The cargo loading pallet Cp includes an upper frame, a lower frame, and a pair of side surface frames connecting the upper frame and the lower frame, and may form one or a plurality of spaces. By inserting the fork Rb into this space, it is possible to load an object including the cargo loading pallet Cp, that is, the cargo loading pallet Cp and a cargo Ca loaded thereon in the example of FIG. 5. In a case where the fork Rb loads and lifts the object, a lower surface Csu of the upper frame comes into contact with the loading surface Rs, and the weight sensor 15 may detect the weight. An upper surface Csb of the lower frame is a surface that comes into contact with the lower surface of the fork Rb in a case where the fork Rb is lowered to the lower side. However, some of the cargo loading pallets do not include the lower frame.

The wheel drive unit 13 drives a wheel for moving the entire forklift R. The fork drive unit 14 may include the lift portion Ra, the driving source, and the like as described above, and corresponds to a part of the forklift R in one example of the above motion control unit. The weight sensor 15 is an example of a sensor that detects a load amount, and may acquire weight information, which is information on the weight.

The operation unit 16 receives a driving operation in a case of manually driving the forklift R, and may include a steering wheel, a lever, and the like. It is also possible to attach an attachment including an actuator that enables automatic driving to the operation unit 16, control the actuator, and operate the operation unit 16 to enable autonomous movement or driving according to a remote operation. In a case where the forklift R is a forklift dedicated to autonomous movement, as illustrated in the drawings, the operation unit 16 may not be provided.

In addition, the forklift R may be a counter forklift in which the position of the fork Rb in the horizontal direction is fixed. Although such an example is given, the forklift R may also be a reach forklift in which the fork Rb extends and contracts in the horizontal direction.

The remote control apparatus 20 may include a control unit 21 that controls the entire apparatus, a communication unit 22 that communicates with the camera 30 and the forklift R, a display unit 23 that displays an operation image for remote operation, and an operation input unit 24 that inputs a content of the operation based on the operation image.

The control unit 21 may include an object information acquisition unit 21a and a specification unit 21b corresponding to the respective examples of the acquisition unit 1a and the specification unit 1b, and may include an obstacle information acquisition unit 21c, which is an example of second acquisition means, a movement control unit 21d, and a fork motion control unit 21e. The control unit 21 may be configured as a computer apparatus including hardware including, for example, one or more processors and one or more memories. Then, at least some of functions of the units mounted in the remote control apparatus 20 may be implemented by one or more processors operating in accordance with a program read from one or more memories.

The object information acquisition unit 21a acquires, as the weight of the object, the load amount of the fork Rb on which the object of the forklift R is loaded. The object information acquisition unit 21a may be configured to acquire the load amount, in this example, the weight information detected by the weight sensor 15, via the communication unit 22.

In addition, the object information acquisition unit 21a receives information on the shape of the object obtained by capturing an image of the object by the sensor 31 from the camera 30 via the communication unit 22. It can be determined which information on the shape of the object obtained from which camera 30 will be acquired, for example, by comparing the position of the forklift R where the object is present with a range in which the camera 30 set in advance may capture images. The shape of the object may be calculated from the shape information obtained from two or more cameras 30.

In addition, instead of the camera 30, for example, a sensor similar to the sensor 31 of the camera 30 may be provided in an upper part of the lift portion Ra of the forklift R, or a sensor similar to the sensor 31 attached to a higher position of the forklift R via a pole or the like may be separately provided.

As described above, the object information acquisition unit 21a may acquire the information on the weight of the object and the information on the shape of the object, and calculate the object's center-of-gravity information based on the results.

The movement control unit 21d may store, for each of a plurality of kinds of movement control values, a movement control value in association with information on a result of movement control by this movement control value. As described above, the movement control values refer to control values for moving the forklift R, and may include values such as a control value of an accelerator, a control value of a brake, and a control value of a steering wheel, and these examples will be described below. However, the movement control values may be, in place of the control value of the accelerator and the control value of the brake, an acceleration or deceleration value indicating acceleration or deceleration of the forklift. Further, as the movement control values, a speed value may be used in place of the acceleration or deceleration value, in which case acceleration or deceleration is performed in accordance with the speed value.

The movement control unit 12d may generate a movement instruction for the forklift R, for example, by reading the corresponding movement control value from the information on the result of the movement control in accordance with the result to be obtained. The remote control apparatus 20 may additionally include an acquisition unit (not shown) that acquires movement control values of the forklift R from the forklift R.

The obstacle information acquisition unit 21c acquires information on the shape of the obstacle transmitted from the camera 30 (hereinafter, this information will be referred to as obstacle information) via the communication unit 22. The obstacle information to be acquired may be only information on a shape of an obstacle, which is an object that is not present in a normal state. The object that is not present in the normal state may be determined by, for example, the obstacle information acquisition unit 21c referring to map information held in the remote control apparatus 20 in advance, the map information being information on an area such as a warehouse or a factory where the forklift R travels, and performing the following determination processing. This determination processing is processing for determining whether or not there is an object in a place other than the place where the forklift R cannot travel in the above area. The obstacle information acquisition unit 21c may perform the above determination processing based on, for example, shape information transmitted from the camera 30 and the position of the image-capturing range of the camera 30. The obstacle information acquisition unit 21c may determine, in a case where it is determined in the above determination processing, that an object is present in a place other than the place where the forklift R cannot travel, this object as an obstacle, and acquire the shape of the obstacle.

Here, an object that is present in the normal state may be registered in the map information and may be excluded by referring to this map information. The normal state may indicate a state as shown in the map information that is held. Further, the normal state may indicate a state as shown in an image acquired from the camera 30 at a predetermined timing. Further, the map information is information on an environment in which the mobile body such as the forklift R moves. Here, the environment in which the mobile body travels may be, for example, an area inside a factory or a warehouse. For example, the map information may indicate a range where the mobile body may travel and may include information on positions of walls or an obstacle.

Further, in a case where the map information includes information on the position of the obstacle, not obstacle information transmitted from the camera 30, the obstacle information acquisition unit 21c may acquire information on the position of the obstacle from the map information as obstacle information. While it is assumed that the camera 30 transmits the obstacle information to the remote control apparatus 20, the camera 30 may transmit the captured image to the remote control apparatus 20 and the obstacle information acquisition unit 21c may acquire obstacle information from the captured image.

The fork motion control unit 21e, which corresponds to a part on the side of the remote control apparatus 20 in one example of the above motion control unit, controls a motion of the fork Rb of the forklift R such as a lifting or lowering motion. Note that the lifting or lowering motion of the fork Rb, which refers to a motion of lifting or lowering the fork Rb, changes the height of the fork Rb. The height of the fork Rb may also be detected by a sensor separately provided in the forklift R or the like, and the lifting or lowering motion may be controlled based on the result of the detection.

The motion of the control target may include, besides the lifting or lowering motion, a motion of expanding or contracting the fork Rb in a case where the forklift is a reach forklift, and may include a motion of changing an inclination angle in a case where the forklift R is configured in such a way that the inclination angle of the fork Rb may be changed. The inclination angle may also be called a tilt angle. Regarding the expansion/contraction motion, an expansion/contraction value of the fork Rb may be detected by a sensor separately provided in the forklift R or the like, and the expansion/contraction motion may be controlled based on the result of the detection. Regarding the motion of changing the tilt angle, the tilt angle of the fork Rb may be detected by a sensor separately provided in the forklift R or the like, and the change motion may be controlled based on the result of the detection.

The specification unit 21b specifies a path along which the forklift R travels to the place where the object is unloaded in accordance with the safety level in conveying the object in the forklift R. The safety level may be determined based on the movement control values read from the movement control unit 21d and information including object's center-of-gravity information acquired in the object information acquisition unit 21a.

The object's center-of-gravity information may include a center-of-gravity position Gc of the cargo Ca and the cargo loading pallet Cp, which are examples of the object, and a force Fgc applied to the center-of-gravity position Gc. The object information acquisition unit 21a may also acquire, besides object's center-of-gravity information, information on a combined center of gravity expressed by a center-of-gravity position Gs of a combined center of gravity of the object and the forklift R, and a force Fgs applied to the center-of-gravity position Gs. Hereinafter, information on the combined center of gravity is referred to as combined center-of-gravity information. Then the safety level may be determined based on the movement control values read from the movement control unit 21d and at least one of the object's center-of-gravity information or the combined center-of-gravity information acquired in the object information acquisition unit 21a. The center-of-gravity position Gs and the force Fgs of the combined center of gravity may be calculated from the center-of-gravity position Gc and the force Fgc, and a center-of-gravity position Gr of the forklift R and a force Fgr applied to the center-of-gravity position Gr.

In a situation in which the forklift R stops or a situation in which it is assumed that the forklift R stops during a path specification, each of the force Fgc, the force Fgr, and the force Fgs is only the force due to the weight. In a case where, for example, the forklift R is stopped, the force Fgs applied to the center-of-gravity position Gs of the combined center of gravity may be a value obtained by adding the weight of the object and the weight of the forklift R. On the other hand, in a case where the forklift R is actually moving or in a case in which it is assumed that the forklift R moves during the path specification, a centrifugal force and an inertial force are also added to the force Fgc, the force Fgr, and the force Fgs.

As described above, the specification unit 21b may calculate information on the safety level and specify a path in accordance with this information, or receive information on a safety level externally calculated and specify a path in accordance with this information. In this example, only the former example will be described. However, these are merely examples, and the specification unit 21b may receive, for example, movement control values and object's center-of-gravity information, and specify a path in such a way that the safety level is taken into account based on the movement control values and the object's center-of-gravity information that have been input.

In the example described here, the specification unit 21b first generates, based on map information including at least a range where the forklift R may move, a temporary path from the current location to the place where the cargo Ca is unloaded, using a predetermined algorithm. The predetermined algorithm to be applied may be, for example, but not limited to, reeds shepp.

Further, this map information may also be called environmental map information. While obstacle information acquired by the obstacle information acquisition unit 21c may be reflected in the map information used during generating the temporary path, the temporary path may be generated based on the map information and the obstacle information even in a configuration in which the obstacle information is not reflected in the map information. This map information may be stored in a storage apparatus or the like provided in the control unit 21. Note that similar map information may also be stored in a storage apparatus provided in the control unit 11 of the forklift R for autonomous movement control.

Next, the specification unit 21b calculates various kinds of movement control values for enabling the forklift R to travel along the generated temporary path. Here, as described above, in the movement control unit 21d may store, for each of a plurality of kinds of movement control values, the movement control value and information on a result of movement control by this movement control value in such a manner that they are associated with each other. The specification unit 21b calculates various kinds of movement control values for enabling the forklift R to travel along the generated temporary path. In this calculation, at least one of an initial value, an upper-limit value, or a lower-limit value may be set for each of various kinds of movement control values of an accelerator, a brake, and a steering wheel.

Then, the specification unit 21b performs at least one of calculation processing for calculating a force applied to the center of gravity of the object in accordance with the various kinds of movement control values that have been calculated and the object's center-of-gravity information, or processing for calculating a force applied to the combined center of gravity of the forklift R and the object in accordance with the various kinds of movement control values that have been calculated and the combined center-of-gravity information. Then, the specification unit 21b determines a safety level, for example, by estimating a safety level in accordance with the calculated force. Here, in a case where only the force applied to the combined center of gravity is calculated, a safety level against overturning of the forklift R during traveling is mainly estimated. In a case where only the force applied to the center of gravity of the object is calculated, a safety level against falling of the cargo Ca, or the cargo Ca and the cargo loading pallet Cp during traveling or at a timing just after it stops traveling is estimated. Further, at this time, not only the safety level against falling of the object but also a safety level against damage of the cargo Ca that occurs as a result of the cargo Ca moving relative to the forklift R may be estimated. A situation in which the cargo Ca is damaged may include a situation in which the cargo Ca is damaged as it collides with an outer wall or another obstacle in a case where it slightly moves relative to the fork Rb, or a situation in which the cargo Ca is damaged as it collides with the lift portion Ra in a case where the cargo Ca suddenly moves relative to the fork Rb, and so on.

The safety level may be estimated by any method. As to the safety level regarding overturning, it may be determined whether or not that the forklift R is likely to overturn or the possibility that the forklift R may overturn may be determined using a known calculation method. As to the safety level regarding falling, it may be determined whether or not the object is likely to fall or the possibility that the object may fall may be determined taking into consideration a frictional coefficient between the cargo Ca and the cargo loading pallet Cp, a frictional coefficient between the cargo loading pallet Cp and the fork Rb, or the like. Since estimating the safety level means estimating a danger level, information on a safety level, which is the result of the estimation, may be handled as information on a danger level.

Here, since various kinds of movement control values vary according to the straights, curves, slopes, road conditions or the like on the temporary path, the specification unit 21b calculates, for each section of the temporary path where a change occurs, various kinds of movement control values. Then, the specification unit 21b calculates, for each section, forces and estimates the safety level.

Then the specification unit 21b specifies a path based on the estimated safety level and the generated temporary path, for example, by correcting at least one of the generated temporary path or various kinds of movement control values. The correction performed by the specification unit 21b need not be performed as long as the safety level reaches a predetermined level. Further, after the specification unit 21b corrects at least one of the generated temporary path or various kinds of movement control values, the specification unit 21b may repeat processing of calculation of the forces and estimation of the safety level until the safety level reaches a predetermined level.

Note that, of the functions of the specification unit 21b, functions other than the function of finally specifying a path, that is, functions of generating a temporary path, calculating movement control values, calculating forces, and determining a safety level may be performed in a part other than the specification unit 21b. For example, the control unit 21 of the remote control apparatus 20 may include the following generation unit, control value calculation unit, force calculation unit, and determination unit, although they are not shown in the drawings. The above generation unit is one example of generation means for generating a temporary path in accordance with map information including a range where the mobile body such as the forklift R may move. The above control value calculation unit is one example of control value calculation means for calculating movement control values for enabling the mobile body such as the forklift R to travel along the generated temporary path. The above force calculation unit is one example of force calculation means for performing at least one of the following first calculation processing or second calculation processing. The first calculation processing is processing for calculating a force applied to a center of gravity of the object in accordance with calculated movement control values and the object's center-of-gravity information. The second calculation processing is processing for calculating a force applied to the combined center of gravity of the mobile body and the object in accordance with the calculated movement control values and the combined center-of-gravity information. The above determination unit is one example of determination means for determining the safety level in accordance with the calculated force. Then the specification unit 21b specifies a path based on the determined safety level and the generated temporary path.

Further, as described above, the remote control apparatus 20 may include the obstacle information acquisition unit 21c that acquires information on an obstacle that is present in an area that may be specified as a path. In this case, the path may be calculated based on the obstacle information. In a case where it is detected that an obstacle has been placed after the path is calculated, the path may be calculated again. Further, in this case, the safety level may be determined based on the movement control values, the object's center-of-gravity information, and the obstacle information.

Further, the fork motion control unit 21e may perform control for adjusting the position of the forklift R where the object is loaded based on the combined center-of-gravity information, which is information on a combined center of gravity of the forklift R and the object. As described above, the combined center-of-gravity information may be expressed by the center-of-gravity position Gs of the combined center of gravity of the object and the forklift R, and the force Fgs applied to the center-of-gravity position Gs. The method for calculating the combined center-of-gravity information has already been described above. The position where the object is loaded may refer to the position of the cargo Ca or the position of the cargo Ca and the cargo loading pallet Cp relative to the fork Rb, that is, the loading position relative to the fork Rb. While the target to be adjusted may be, although it varies depending on the motion that the forklift R may perform, the height of the fork Rb, an expansion/contraction value of a reach, a tilt angle, or the like.

In this case, the specification unit 21b may specify a path in accordance with the safety level obtained from the result of performing control for adjustment. In this manner, by adjusting the position where the object is loaded in accordance with the combined center of gravity, the safety level is improved, Then re-calculation of a path including estimation of the safety level is performed from various kinds of movement control values or the like. It is thus possible to perform movement control and specify a path with a high safety level.

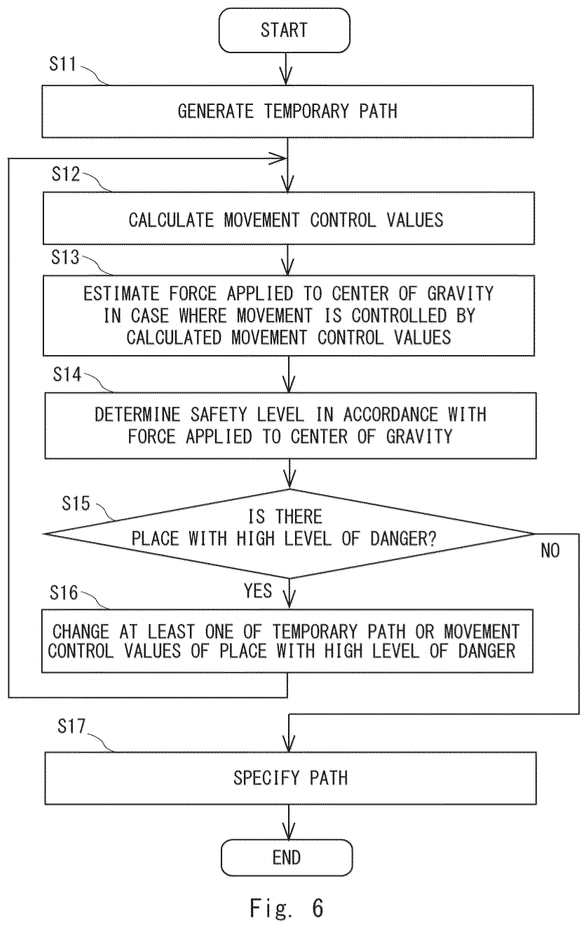

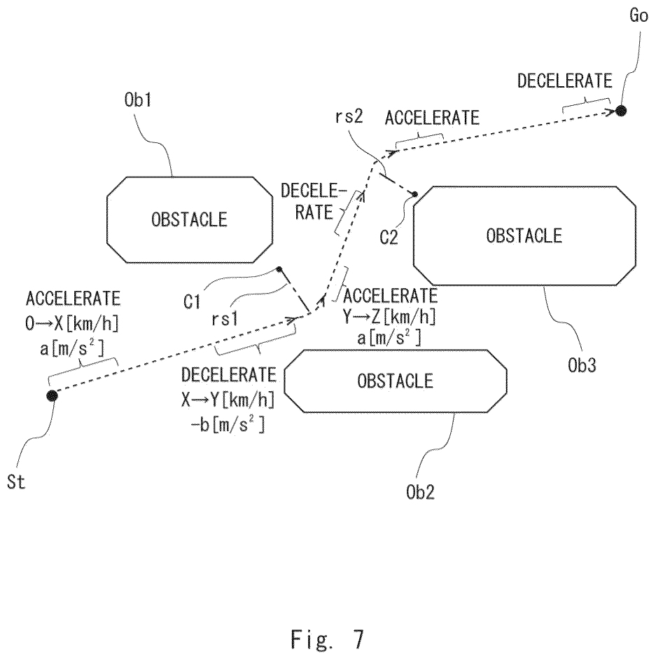

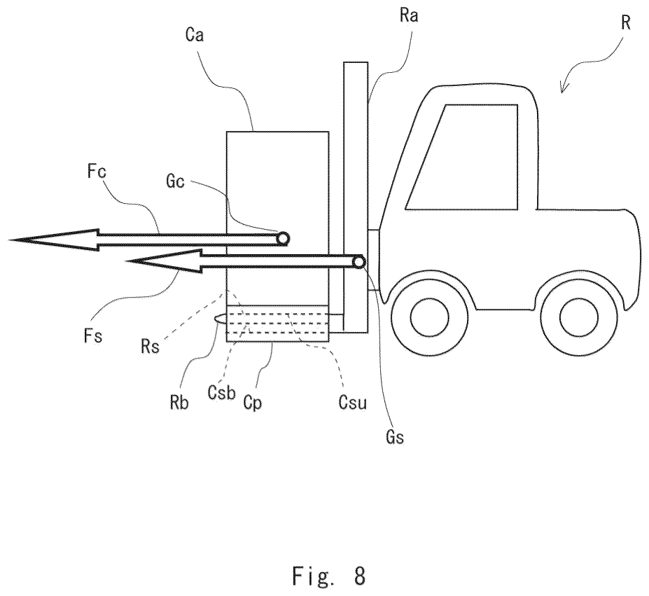

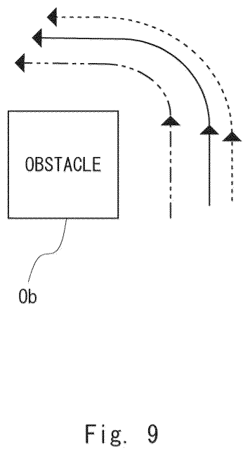

Next, with reference to FIGS. 6 to 9, an example of path specification processing in the specification unit 21b will be described. FIG. 6 is a flowchart for describing an example of path specification processing in the remote control apparatus 20 in the path specification system 100 of FIG. 4. FIG. 7 is a schematic diagram illustrating one example of a path calculated in the path specification processing of FIG. 6, and FIG. 8 is a schematic diagram for describing safety level determination processing in the path specification processing of FIG. 6. Further, FIG. 9 is a schematic diagram illustrating one example of a state in which an obstacle is avoided on the path calculated in the path specification processing of FIG. 6.

In the path specification processing illustrated in FIG. 6, first, the specification unit 21b generates, using a predetermined algorithm, a temporary path from the current location to the place where the cargo Ca is unloaded based on, for example, map information in which the obstacle information illustrated in FIG. 7 is reflected (Step S11).

Next, the specification unit 21b calculates various kinds of movement control values for enabling the forklift R to travel along the generated temporary path (Step S12). In this example, an example in which a speed of the mobile body, acceleration or deceleration, and a turning radius are calculated as movement control values of the forklift R and there are obstacles Ob1-Ob3 between a current location St and an unloading place Go as illustrated in FIG. 7 will be described.

In this example, first, an arrival speed, acceleration, and no turning radius in an acceleration section from the current location St are calculated. No turning radius means that the mobile body travels straight ahead. Next, for a section which is between the obstacles Ob1 and Ob2 and before the obstacle Ob3, an arrival speed, acceleration, and no turning radius are calculated as a deceleration period. Next, for the following section, a turning center C1 and a turning radius rs1 are calculated as a turning period, and a constant turning speed is calculated as well, although it is not illustrated. As a matter of course, the turning speed may be calculated not to be constant. Next, for each of linear sections before the mobile body passes through an area between the obstacle Ob2 and the obstacle Ob3, movement control values are calculated for each of an acceleration section and a deceleration period. Next, for the following section, a turning center C2 and a turning radius rs2 are calculated as a turning period, and a constant turning speed is calculated as well, although it is not illustrated. Finally, for the section in which the mobile body travels straight toward the unloading place Go, movement control values are calculated for each of an acceleration section and a deceleration section. Note that there is a constant-speed section between the acceleration section and the deceleration section. For this constant-speed section as well, movement control values at least indicating that the mobile body travels straight ahead at a constant-speed may be calculated.

Regarding Step S12, the specification unit 21b calculates, for each section, based on various kinds of movement control values that have been calculated, at least one of a force applied to a combined center of gravity of the forklift R and the object or a force applied to the center of gravity of the object (Step S13). For example, the specification unit 21b estimates, for each section, based on the acceleration or deceleration of the forklift R, or the speed at the time of turning and the turning radius, at least one of the magnitude of the force applied to the center of gravity of the object or the magnitude of the force applied to the combined center of gravity while the forklift R travels along the generated temporary path.

Next, the specification unit 21b estimates the safety level for each section in accordance with the force calculated in Step S13 (Step S14). As described above, in a case where only a force applied to the combined center of gravity is calculated, a level of safety against overturning of the forklift R during traveling may be mainly estimated. In a case where only a force applied to the center of gravity of the object is calculated, a level of safety against falling of an object or a damage of the object may be estimated.

For example, in a case where it is estimated that a force Fc in the horizontal direction applied to the center of gravity Gc of the object illustrated in FIG. 8 is greater than a static friction force between the cargo Ca and the cargo loading pallet Cp or a static friction force between the upper surface of the fork Rb and the cargo loading pallet Cp, it is determined that the forklift R is not safe. This determination may be performed at a time of deceleration in a section in which the forklift R travels straight or for a turning section. As described above, the determination that the forklift R is not safe means a determination that it is in danger. That is, a high safety level is equivalent to a low danger level and a low safety level is equivalent to a high danger level. The both static friction forces may be measured in advance, and predetermined values may be set. In a case where predetermined values are set, it may be determined that the forklift R is not safe in a case where the centrifugal force or the inertial force becomes greater than a static friction force of a predetermined value and the value in accordance with the weight of the object. Further, for a turning section, in a case where a maximum centrifugal force applied to the center of gravity Gc of the object is greater than a predetermined threshold, it may be determined that it is not safe, that is, in danger. Further, in a case where it is estimated that the centrifugal force and the inertial force applied to the combined center of gravity Gs is greater than a force applied to the combined center of gravity Gs due to the forklift R and the mass of the object, it may be determined that the forklift R is in danger.

In any of the methods for determining the safety level, by setting, for example, thresholds of forces such as a static friction force, a centrifugal force, and an inertial force to small values, a path finally specified may have a sufficient margin for preventing the object from falling or the forklift R from overturning. In this manner, a safety level with a sufficient margin of safety may be determined.

As illustrated, the safety level may be determined based on various kinds of movement control values, object's center-of-gravity information, and combined center-of-gravity information.

Further, the specification unit 21b may be configured to output a result of determining the safety level or the danger level by using a learning model which is obtained by performing machine learning using learning data indicating various kinds of movement control values of the forklift R and a result of overturning or falling of a cargo. In this case, the specification unit 21b may enter, for each section, various kinds of movement control values into this learning model and obtain the result of determining the safety level or the danger level for this section. The algorithm and so on of this learning model are not limited.

Then the specification unit 21b determines whether or not there is a place with a high level of danger for the estimated safety level for each section (Step S15). In a case where there is no place with a high level of danger, the specification unit 21b specifies the temporary path as the path along which the forklift R moves (Step S16), and the processing is ended. The place with a high level of danger may refer to a section where the danger level is high.

On the other hand, in a case where it is determined to be YES in Step S15, at least one of a path or various kinds of movement control values of a place with a high level of danger is changed (Step S16), and the process returns to Step S12. On the other hand, in a case where the movement control values have been changed in Step S16, the processing in Step S12 will not be performed even after the process returns to Step S12, and the process proceeds to Step S13. The specification unit 21b repeats processing in the change in Step S16 and Steps S12-S14 until the safety level reaches a predetermined level, that is, until in a case where it is determined to be NO in Step S15.

The specification unit 21b may perform the change in Step S16 while determining whether the time for the forklift R to move to the unloading place Go may be short. Referring to FIG. 9, a processing example of the specification unit 21b which is based on a factor other than the factor that the time for the forklift R to move to the unloading place Go may be short will be described. FIG. 9 illustrates, by using arrows, three patterns of temporary paths of the forklift R that turns while avoiding an obstacle Ob. In FIG. 9, the temporary paths shown by an alternate long and two short dashed line arrow, a solid arrow, and a dashed arrow are temporary paths in which turning radii to avoid the obstacle Ob are increased in this order, and their turning speeds may be the same or different from one another. In this example, for the sake of convenience, it is assumed that the following temporary paths are used. It is assumed that the temporary path shown by the alternate long and two short dashed line arrow in FIG. 9 indicates a temporary path in which the turning radius is made smaller than a reference value and the speed is lower than that during traveling straight ahead. Further, the temporary path shown by the solid arrow in FIG. 9 indicates a temporary path in which the turning radius is the reference value and the speed is lower than that during traveling straight ahead. Further, the temporary path shown by the dashed arrow in FIG. 9 indicates a temporary path where the turning radius is made greater than the reference value and the speed is about the same as that during traveling straight ahead.

The specification unit 21b may perform the change in Step S16 so that the temporary path becomes such that the forklift R does not have to travel along a path passing through a place just close to an edge of a corner formed by the obstacle Ob as shown by, for example, the alternate long and two short dashed line arrow in FIG. 9. For example, the specification unit 21b may perform the change in Step S16 while determining whether the temporary path enables the forklift R to travel with a sufficient amount of margin, as shown by the solid arrow and the dashed arrow in FIG. 9. Accordingly, it is possible to improve the safety level of traveling and reduce the number of times Steps S12-S14 and S16 are repeated until the safety level reaches a predetermined level. Note that the corner may be formed by a pole or the like that is originally present near a temporary path along which the forklift R travels even in a case where there is no obstacle Ob. In the example illustrated in FIG. 9, one of the three temporary path patterns may be selected taking into consideration the safety level in a section near the obstacle Ob, that is, the section shown in FIG. 9, and a safety level in a temporary path in a section next to the section in FIG. 9, or a temporary path along which the forklift R may travel in the section next to the section in FIG. 9.

Further, in the generation of the temporary path in Step S11, the mobile object formed of the forklift R and the object may be made to have a margin of a predetermined value in the width direction of the temporary path, that is, the transverse direction with respect to the traveling direction of the temporary path. That is, while the path is generated, the size of the moving object may be set in such a manner that it becomes larger than its actual size by a predetermined value in the transverse direction. Accordingly, it is possible to reduce the possibility that the determination in Step S15 may become YES and to improve the safety level. As a matter of course, since it is possible that the object may fall forward in the forklift R, the mobile object may be made to have a margin of a predetermined value in the forward traveling direction of the temporary path.

Further, the movement control values may be calculated in Step S12 in various methods as illustrated in FIG. 9 for the obstacle Ob. For example, the specification unit 21b may calculate movement control values such that the turning radius is made smaller than the reference value and the speed is reduced compared to that during traveling straight ahead, as shown by the alternate long and two short dashed line arrow in FIG. 9. Further, the specification unit 21b may calculate movement control values such that the turning radius is kept to be the reference value and the speed is reduced compared to that during traveling straight ahead, as shown by the solid arrow in FIG. 9. Further, the specification unit 21b may calculate movement control values such that the turning radius is made greater than the reference value and the speed is the same as that during traveling straight ahead, as shown by the dashed arrow in FIG. 9.

Further, in Step S12, besides the movement control values, various kinds of motion control values, which are various kinds of control values for performing control of a fork motion in the fork motion control unit 21e may be calculated. The motion control values may include a control value for the lifting or lowering motion of the fork Rb, and a control value of the lifting or lowering motion may be a value indicating the height of the fork Fb after the motion, an acceleration or deceleration value indicating acceleration or deceleration of lifting or lowering, a speed of lifting or lowering, or the like. In a case where the forklift R is a reach forklift, the motion control values may include a control value of the expansion/contraction motion of the fork Rb, and a control value of the expansion/contraction motion may be a value indicating the expansion/contraction length. In a case where the forklift R is configured to be able to change the tilt angle of the fork Rb, the motion control values may include a control value of the motion of changing the tilt angle, such as a value indicating the tilt angle. In a case where the movement control values and the motion control values are calculated in Step S12, Steps S13 and S16 are as follows. That is, in Step S13, the specification unit 21b calculates the force in a case where the movement control is performed by the calculated movement control values and the force in a case where the motion control is performed by the calculated motion control values. In Step S16, the motion control values may also be changed.

As described above, in the present example embodiment, an example in which the mobile body is a forklift has been mainly described. However, the configuration and shape of the forklift are not limited to those exemplified, and even a mobile body other than the forklift may be applied.

Examples of the mobile body include a crane vehicle or a robot that hangs an object from a hole or the like provided in the object, a robot that holds a handle or the like provided in the object in the vertical direction and lifts or lowers the object with an arm, and a robot that may load the object on the arm or the like.

The loading unit in the case of the method of suspending the object corresponds to a hanging tool including a hook, a wire, and the like, and a sensor such as a weight sensor for detecting the load amount in this case may be installed in a winch portion of the hook or the wire. In this case, loading an object means that the object is hung and lifted by being hooked on a hanging tool under a part of the object, for example, a hole, or a protrusion provided in the object. In the case of a robot that grips an object in the vertical direction, a lower member of the grip portion corresponds to the loading unit, and a sensor that detects the load amount in this case may be provided on an upper surface of the lower member of the grip portion or an operating portion of an arm that pulls up the grip portion. In this case, loading the object corresponds to placing the object on the lower member of the grip portion and sandwiching the object with the upper member of the grip portion. In the case of a robot capable of loading cargo and cargo loading pallet on an arm or the like, similarly to the forklift, the loading unit corresponds to a portion on which an object is loaded, and an installation position of a sensor that detects a load amount may be the same as the forklift or may be an operating portion of the arm or the like. In this case, loading the object means loading the object on the arm or the like similarly to the forklift.

In the mobile body including the loading unit in the case of the method of suspending the object, the centrifugal force applied to the object varies depending on, for example, the length of the wire at the time of turning. Further, this centrifugal force causes the object to move, for example, back and forth, left and right to collide with an obstacle. In order to prevent this situation, a sufficient margin of the width of the mobile body in the transverse direction and the length thereof in the front-back direction may be set.

In addition, the type of the above mobile body is not limited to a mobile body that moves on the ground, and may be an object that moves under water or over water, such as a ship or an underwater drone, or an object (flight vehicle) that moves in the air, such as an aircraft or a flying drone. Furthermore, the mobile body may be a mobile robot such as an automated guided vehicle (AGV).

Further, as described above, it does not matter whether the mobile body has a function of moving according to autonomous control, a function of moving by an operation by an operator, or both functions. In a case in which the mobile body has a function of moving according to autonomous control, the mobile body performs automatic driving (autonomous driving) based on information of various sensors mounted on the mobile body. Further, the mobile body may be configured to be able to switch between, for example, automatic driving and manual driving by an occupant (for example, a driver in a vehicle in the case of an automatic driving vehicle).

### Second Example Embodiment

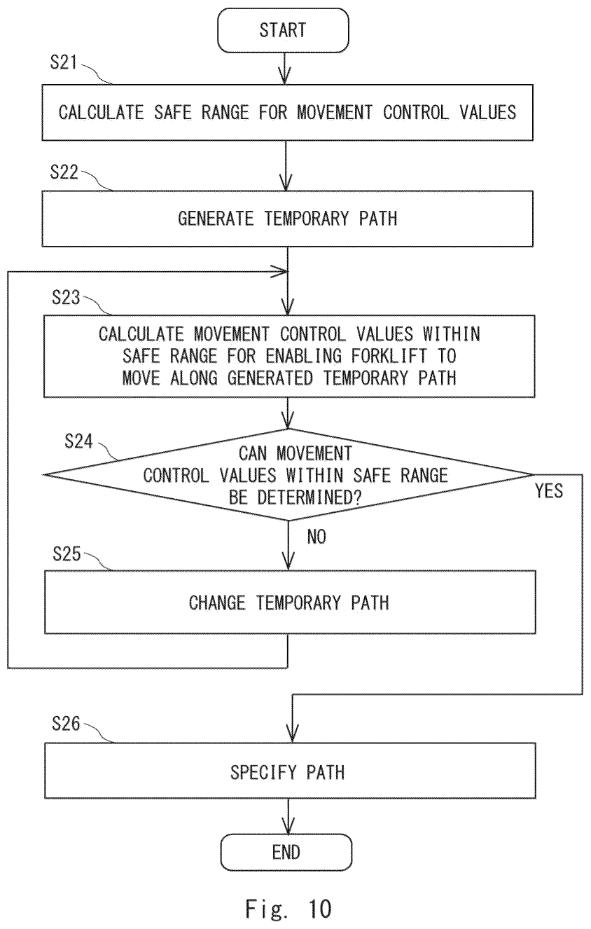

A second example embodiment will be described with reference to FIG. 10, focusing on differences from the first example embodiment, but various examples described in the first example embodiment may be applied in the present example embodiment. In addition, since the function of the path specification system according to the present example embodiment is the same as the function of the path specification system 100 of FIG. 4 except for a part thereof, the present example embodiment will also be described based on the notation of the configuration examples and the like of FIGS. 4, 5, and 8.

First, a specification unit 21b according to the present example embodiment will be described. An order in which the path is specified or the like in the specification unit 21b according to the present example embodiment is different from that in the specification unit 21b in the first example embodiment.

The specification unit 21b according to the present example embodiment first calculates, based on at least one of the combined center-of-gravity information, which is information on the combined center of gravity of the forklift R and the object, or the object's center-of-gravity information, which is information on the center of gravity of the object, an acceptable range of the movement control values in which the safety level in conveying the object in the forklift R may be ensured. In this case as well, the calculation may be performed for various kinds of movement control values.

Next, the specification unit 21b generates, based on the map information including at least a range where the forklift R may move, a temporary path from a current location or the like to a place where a cargo Ca is unloaded using a predetermined algorithm. In the present example embodiment as well, the obstacle information may be reflected in the map information, or the specification unit 21b may calculate a path based on the map information and the obstacle information. Further, a predetermined algorithm to be applied may be, for example, but not limited to, reeds shepp.

Then the specification unit 21b specifies various kinds of movement control values in accordance with the calculated acceptable range by determining, for example, various kinds of movement control values for enabling the mobile body to move along the generated temporary path within the calculated acceptable range. Further, in a case where the determination of the value within the specified acceptable range cannot be executed by at least one of various kinds of movement control values, the specification unit 21b may specify various kinds of movement control values again after changing the generated temporary path, and may repeat this procedure until the determination may be made within the acceptable range. Then, the specification unit 21b specifies a path in accordance with the safety in conveying the object in the mobile body determined based on the specified various kinds of movement control values and the generated temporary path.

Note that, of the functions of the specification unit 21b according to the present example embodiment, functions other than the function of finally specifying a path, that is, functions of calculating the acceptable range, generating the temporary path, and specifying the movement control values may be performed by a unit other than the specification unit 21b. For example, the control unit 21 of the remote control apparatus 20 may include the following calculation unit, temporary path generation unit, and control value specification unit although they are not shown in the drawings. The above calculation unit is one example of calculation means for calculating the acceptable range of the movement control values based on at least one of the object's center-of-gravity information or the combined center-of-gravity information. The above temporary path generation unit is one example of temporary path generation means for generating a temporary path in accordance with map information including the range where the mobile body such as the forklift R may move. The above control value specification unit is one example of control value specification means for specifying movement control values for enabling the mobile body to move along the generated temporary path in accordance with the calculated acceptable range. Then, the specification unit 21b specifies a path in accordance with safety in conveying the object in the mobile body determined based on the specified movement control values and the generated temporary path.

Referring to FIG. 10, one example of the above path specification processing will be described. FIG. 10 is a flowchart for describing an example of path specification processing in the path specification system 100 according to the present example embodiment.

In the path specification processing illustrated in FIG. 10, first, the specification unit 21b calculates a safe range for the movement control values (Step S21). The safe range indicates an acceptable range in view of safety. The calculated acceptable range is not a range that depends on a section of a temporary path or a section of a path that may be specified.

In Step S21, the specification unit 21b calculates an acceptable range of the movement control values where the safety level in conveying the object in the forklift R may be ensured based on at least one of the combined center-of-gravity information or the object's center-of-gravity information. For example, the specification unit 21b calculates a safe value among the movement control values of the forklift R based on the combined center-of-gravity information and the object's center-of-gravity information. More specifically, the specification unit 21b calculates an upper-limit value of the acceleration or deceleration, a turning radius, an upper-limit value of the turning speed, or the like estimated to be safe based on the force applied to the forklift R and the object.

Further, in Step S21, a table showing, for example, a relationship among the object's center-of-gravity information, the combined center-of-gravity information, and acceleration or deceleration, and a relationship among the object's center-of-gravity information, the combined center-of-gravity information, a speed at the time of turning, and a turning radius may be created in advance by a simulation, and this table may be used. The specification unit 21b may refer to this table to acquire acceptable ranges of various kinds of movement control values from the combined center-of-gravity information and the object's center-of-gravity information.

Next, the specification unit 21b generates, using a predetermined algorithm, a temporary path from a current location or the like to a place where a cargo Ca is unloaded based on map information at least including the range where the forklift R moves (Step S22). For example, the specification unit 21b generates, using a predetermined algorithm, a temporary path from the current location to the place where the cargo Ca is unloaded based on the map information in which the obstacle information illustrated in FIG. 7 is reflected.

Then, the specification unit 21b determines various kinds of movement control values for enabling the forklift R to move along the generated temporary path within the acceptable range calculated in Step S22 (Step S23).

Next, the specification unit 21b determines whether or not all the various kinds of movement control values can be determined in the determination of the values within the calculated acceptable range (Step S24). In a case where it is determined to be YES, the temporary path generated in Step S22 is specified as a path along which the forklift R will be traveled (Step S26), and the processing is ended.

On the other hand, in a case where it is determined to be NO in Step S24, that is, in a case where the determination of a value cannot be performed for at least one item, the specification unit 21b changes the calculated temporary path, that is, corrects the temporary path (Step S25), and the process returns to Step S23, where determination and the like of various kinds of movement control values are performed again. In Step S25, in a case where, for example, a temporary path regarding a turn is corrected, a change may be made so as to advance the start of the turn or a change may be made so as to increase the turning radius.

Here, in a case where it is estimated that the forklift R may overturn or the object on the forklift R may fall in the temporary path or the turning speed calculated first, a method for correcting the three path patterns may be, for example, employed, as illustrated in FIG. 9.

First, as shown by the alternate long and two short dashed line arrow in FIG. 9, movement control values may be corrected to those in which the turning radius is made smaller than the value calculated first and the speed calculated first is reduced. In this correction method, the mobile body is decelerated, in which case it is possible that the object may be tilted forward and may fall and it is thus required to take some measures such as avoiding sudden deceleration. This correction method is effective in a case where a width of a temporary path along which the forklift R may move is narrow. The specification unit 21b may also correct movement control values to those in which the turning radius is kept to be a reference value and the speed is reduced compared to that during traveling straight ahead, as shown by the solid arrow in FIG. 9. In this correction method, the mobile body is decelerated, in which case it is likely that the object may be tilted forward and may fall and it is thus required to take some measures such as avoiding sudden deceleration. The specification unit 21b may also correct movement control values to those in which the turning radius is made greater than the reference value and the speed that is the same as that during traveling straight ahead is maintained, as illustrated in the dashed arrow in FIG. 9. This correction method, in which acceleration or deceleration does not occur, may be applied to a case where the possibility that the object may fall or the forklift R may overturn is low but a width of a temporary path along which the forklift R may move is large. On the other hand, in a case where the width of the temporary path along which the forklift R may move is narrow, the correction method is difficult to be applied. Therefore, this correction method may be selected as appropriate in accordance with the range where the forklift R may travel, the width of a path where the forklift may travel, the weight of the object, the speed of the mobile body, the force applied to the center of gravity of the object, the force applied to the combined center of gravity, or the like.

As described above, in a case where it is difficult for the forklift R to move along the temporary path calculated within the acceptable range for various kinds of movement control values; for example, in a case where the forklift R cannot turn along the temporary path, the specification unit 21b corrects the corresponding part of the calculated temporary path. Then, the processing of Steps S23-S25 is repeated until all the various kinds of movement control values are determined within the acceptable range.

As described above, according to the present example embodiment, in addition to the effects of the first example embodiment, a path and movement control values may be quickly determined since the acceptable range of the movement control values is determined first.

Note that, in the present example embodiment as well, a fork motion control unit 21e may be included. The fork motion control unit 21e may perform control for adjusting the position of the forklift R where the object is loaded based on the combined center-of-gravity information. In the present example embodiment as well, the specification unit 21b may specify the path in accordance with the safety level of the result of performing control for adjustment. That is, the specification unit 21b may improve the safety level by adjusting the position where the object is loaded in accordance with the combined center-of-gravity information. Then the specification unit 21b may calculate various kinds of movement control values in a safe range, generate a temporary path, and calculate movement control values which enable the mobile body to move along the temporary path in a safe range. Accordingly, it is possible to perform movement control and specify a path with a high safety level.

Further, in the present example embodiment as well, regarding various kinds of motion control values, which are various kinds of control values for controlling the fork motion by the fork motion control unit 21e, the safe range may be calculated in Step S21. These motion control values as well as the movement control values may be the target to be calculated and the target to be determined in Steps S23 and S24 as well.

### Third Example Embodiment

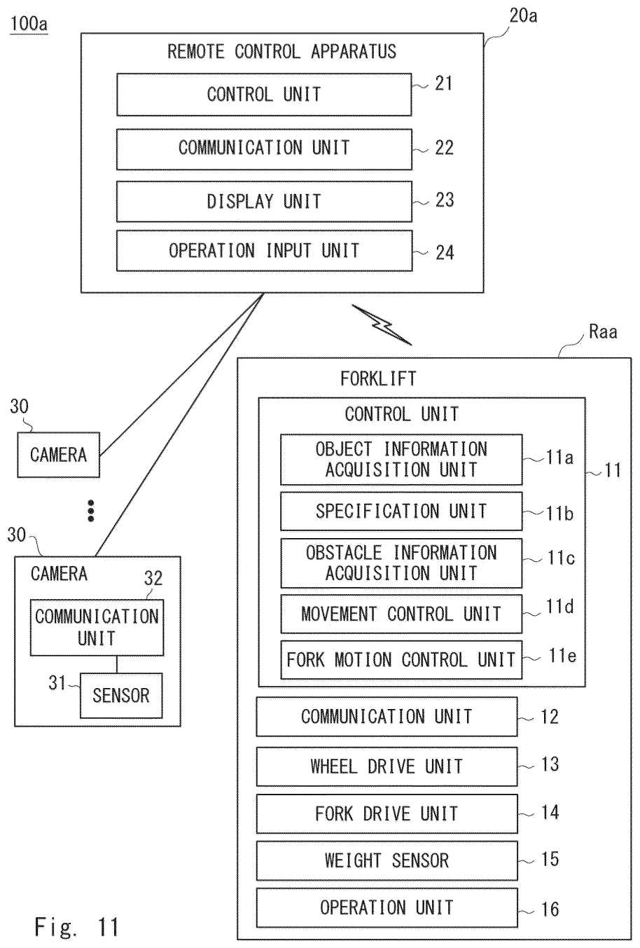

A third example embodiment will be described with reference to FIG. 11, focusing on differences from the first example embodiment, but various examples described in the first and second example embodiments may be applied in the present example embodiment. FIG. 11 is a block diagram illustrating a configuration example of a path specification system according to the present example embodiment.

As illustrated in FIG. 11, a path specification system 100a according to the present example embodiment is a system in which a distribution form of functions is different from that of the path specification system 100 illustrated in FIG. 4. The path specification system 100a includes one or a plurality of cameras 30, a remote control apparatus 20a, and one or a plurality of forklifts Raa.

The remote control apparatus 20a includes, besides a control unit 21, a communication unit 22, a display unit 23, and an operation input unit 24. The remote control apparatus 20a may accept, for the forklift Raa, for example, a user operation such as specification of an unloading place using the display unit 23 and the operation input unit 24, and transmit this specification to the forklift Raa via the communication unit 22.

In the forklift R in FIG. 4, the forklift Raa includes, in a control unit 11, an object information acquisition unit 11a and a specification unit 11b respectively corresponding to examples of the acquisition unit 1a and the specification unit 1b, and includes an obstacle information acquisition unit 11c, a movement control unit 11d, and a fork motion control unit 11e.

The object information acquisition unit 11a may acquire shape information from the camera 30 via a communication unit 12 and acquire information on a weight from the weight sensor 15. The obstacle information acquisition unit 11c may acquire shape information on an obstacle from a camera 30 via the communication unit 12. Note that the information from the camera 30 may be configured to be received via the remote control apparatus 20a.

The movement control unit 11d controls the movement of the forklift Raa by controlling the wheel drive unit 13. The fork motion control unit 11e controls a motion of the fork Rb such as the height thereof by controlling the fork drive unit 14. As described above, the motion of the control target may include a motion for changing a tilt angle or an expansion/contraction value of the fork Rb depending on the function of the forklift Raa. The specification unit 11b specifies a path to the place where the object is unloaded in accordance with the safety level in conveying the object in the forklift Raa determined at least based on motion control values and object's center-of-gravity information of the forklift Raa.

As described above, in the present example embodiment, in addition to the effects of the first or second example embodiment, a necessary function may be implemented mainly by the forklift Raa alone. However, as described in the first example embodiment, the configuration of FIG. 4 and the configuration of FIG. 11 are not limited regardless of the form of function distribution. For example, all the components including the camera 30 may be mounted on the forklift. In addition, the functions that may be provided on the side of the remote control apparatus may also be provided in a cloud server or the like.

### Others

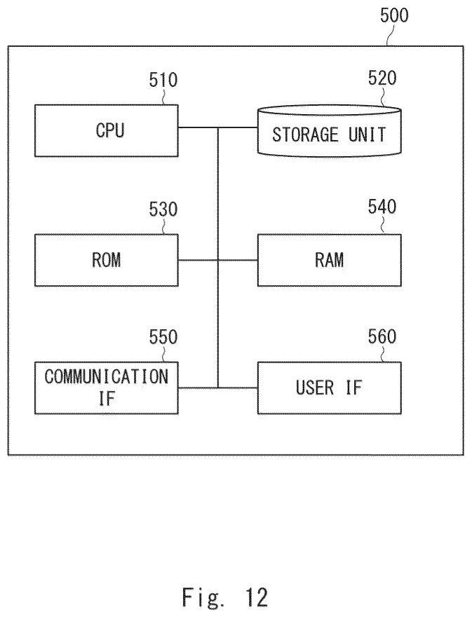

In the present disclosure, the path specification apparatus, the remote control apparatus, the control unit of the forklift, the camera, and the like may include apparatuses such as a computer. FIG. 12 is a block diagram illustrating a configuration example of an apparatus. As illustrated in FIG. 12, an apparatus 500 includes a central processing unit (CPU) 510, a storage unit 520, a read only memory (ROM) 530, and a random access memory (RAM) 540 as a control unit. Further, the apparatus 500 may include a communication interface (IF) 550 and a user interface 560.

The apparatus 500 may be used as any of a path specification apparatus, a remote control apparatus, a control unit of a forklift, a camera, and so on. For example, the apparatus 500 may also be used as a control apparatus inside a forklift.

The communication interface 550 is an interface for connecting the apparatus 500 to a communication network through wired communication means, wireless communication means, or the like. The user interface 560 may include, for example, a display unit such as a display. Further, the user interface 560 may include input units such as a keyboard, a mouse, and a touch panel.

The storage unit 520 is an auxiliary storage device that may hold various kinds of information. The storage unit 520 need not necessarily be part of the apparatus 500 and may be an external storage device or a cloud storage connected to the apparatus 500 via a network.

The ROM 530 is a non-volatile storage device. For example, a semiconductor storage device such as a flash memory having a relatively small capacity may be used for the ROM 530. A program that is executed by the CPU 510 may be stored in the storage unit 520 or the ROM 530. The storage unit 520 or the ROM 530 stores various programs for implementing the functions of the respective units in the apparatus 500.

The program includes a group of commands (or software codes) for causing a computer to perform one or more functions that have been described in the example embodiments in a case where the program is read by the computer. The program may be stored in a non-transitory computer-readable medium or a tangible storage medium. As an example and not by way of limitation, a computer-readable medium or tangible storage medium includes a random-access memory (RAM), a read-only memory (ROM), a flash memory, a solid-state drive (SSD) or other memory technology, a compact disc (CD), a digital versatile disc (DVD), a Blu-ray (registered trademark) disk or other optical disk storage, a magnetic cassette, a magnetic tape, a magnetic disk storage, or other magnetic storage devices. The program may be transmitted on a transitory computer-readable medium or a communication medium. As an example and not by way of limitation, the transitory computer readable medium or the communication medium includes propagated signals in electrical, optical, acoustic, or any other form.

The RAM 540 is a volatile storage device. As the RAM 540, various types of semiconductor memory devices such as a dynamic random access memory (DRAM) or a static random access memory (SRAM) may be used. The RAM 540 may be used as an internal buffer for temporarily storing data or the like. The CPU 510 develops a program, stored in the storage unit 520 or the ROM 530, in the RAM 540, and executes the developed program. The function of each unit in the apparatus 500 may be realized by the CPU 510 executing the programs. The CPU 510 may include an internal buffer in which data or the like may be temporarily stored.

Although example embodiments according to the present disclosure have been described above in detail, the present disclosure is not limited to the above-described example embodiments, and the present disclosure also includes those that are obtained by making changes or modifications to the above-described example embodiments without departing from the spirit of the present disclosure. Further, some or all of the above-described example embodiments may be combined as appropriate.

For example, some or all of the above-described example embodiments may be described as the following supplementary notes, but the present disclosure is not limited to the following supplementary notes.

### Supplementary Note 1

A path specification system comprising:
a first acquisition means for acquiring information on a center of gravity of an object loaded on a mobile body; and
specification means for specifying a path to a place where the object is unloaded in accordance with a safety level in conveying the object in the mobile body determined based on a control value for controlling the mobile body and information on the center of gravity of the object.

### Supplementary Note 2

The path specification system according to Supplementary Note 1, comprising:
a second acquisition means for acquiring information on an obstacle that is present in an area that may be specified as the path,
wherein the safety level is determined based on the control value, the information on the center of gravity of the object, and the information on the obstacle.

### Supplementary Note 3

The path specification system according to Supplementary Note 1, wherein the safety level is determined based on the control value, the information on the center of gravity of the object, and information on a combined center of gravity of the mobile body and the object.

### Supplementary Note 4

The path specification system according to any one of Supplementary Notes 1 to 3, wherein
the path specification system performs control for adjusting a position of the mobile body where the object is loaded based on the information on the combined center of gravity of the mobile body and the object, and
the specification means specifies the path in accordance with the safety level of a result of performing the control for the adjustment.

### Supplementary Note 5

The path specification system according to any one of Supplementary Notes 1 to 4, comprising: generation means for generating a temporary path in accordance with map information including a range in which the mobile body may move;
control value calculation means for calculating the control value for enabling the mobile body to travel along the generated temporary path;
force calculation means for performing at least one of processing for calculating a force applied to the center of gravity of the object in accordance with the calculated control value and the information on the center of gravity of the object or processing for calculating a force applied to the combined center of gravity of the mobile body and the object in accordance with the calculated control value and the information on the combined center of gravity of the mobile body and the object; and
determination means for determining the safety level in accordance with the calculated force,
wherein the specification means specifies the path based on the determined safety level and the generated temporary path.

### Supplementary Note 6

The path specification system according to any one of Supplementary Notes 1 to 4, comprising:
calculation means for calculating an acceptable range of the control value based on at least one of the information on the center of gravity of the object or the information on the combined center of gravity of the mobile body and the object;
temporary path generation means for generating a temporary path in accordance with map information including a range in which the mobile body may move; and
control value specification means for specifying the control value for enabling the mobile body to move along the generated temporary path in accordance with the calculated acceptable range,
wherein the specification means specifies the path in accordance with a safety level in conveying the object in the mobile body determined based on the specified control value and the generated temporary path.

### Supplementary Note 7

A path specification apparatus comprising:
a first acquisition means for acquiring information on a center of gravity of an object loaded on a mobile body; and
specification means for specifying a path to a place where the object is unloaded in accordance with a safety level in conveying the object in the mobile body determined based on a control value for controlling the mobile body and information on the center of gravity of the object.

### Supplementary Note 8

The path specification apparatus according to Supplementary Note 7, comprising:
a second acquisition means for acquiring information on an obstacle that is present in an area that may be specified as the path,
wherein the safety level is determined based on the control value, the information on the center of gravity of the object, and the information on the obstacle.

### Supplementary Note 9

The path specification apparatus according to Supplementary Note 7, wherein the safety level is determined based on the control value, the information on the center of gravity of the object, and information on a combined center of gravity of the mobile body and the object.

### Supplementary Note 10

The path specification apparatus according to any one of Supplementary Notes 7 to 9, wherein
the path specification apparatus performs control for adjusting a position of the mobile body where the object is loaded based on the information on the combined center of gravity of the mobile body and the object, and
the specification means specifies the path in accordance with the safety level of a result of performing the control for the adjustment.

### Supplementary Note 11

The path specification apparatus according to any one of Supplementary Notes 7 to 10, comprising:
generation means for generating a temporary path in accordance with map information including a range in which the mobile body may move;
control value calculation means for calculating the control value for enabling the mobile body to travel along the generated temporary path;
force calculation means for performing at least one of processing for calculating a force applied to the center of gravity of the object in accordance with the calculated control value and the information on the center of gravity of the object or processing for calculating a force applied to the combined center of gravity of the mobile body and the object in accordance with the calculated control value and the information on the combined center of gravity of the mobile body and the object; and
determination means for determining the safety level in accordance with the calculated force,
wherein the specification means specifies the path based on the determined safety level and the generated temporary path.

### Supplementary Note 12

The path specification apparatus according to any one of Supplementary Notes 7 to 10, comprising:
calculation means for calculating an acceptable range of the control value based on at least one of the information on the center of gravity of the object or the information on the combined center of gravity of the mobile body and the object;
temporary path generation means for generating a temporary path in accordance with map information including a range in which the mobile body may move; and
control value specification means for specifying the control value for enabling the mobile body to move along the generated temporary path in accordance with the calculated acceptable range,
wherein the specification means specifies the path in accordance with a safety level in conveying the object in the mobile body determined based on the specified control value and the generated temporary path.

### Supplementary Note 13

A path specification method comprising:
acquiring information on a center of gravity of an object loaded on a mobile body; and
specifying a path to a place where the object is unloaded in accordance with a safety level in conveying the object in the mobile body determined based on a control value for controlling the mobile body and information on the center of gravity of the object.

### Supplementary Note 14

The path specification method according to Supplementary Note 13, comprising:
acquiring information on an obstacle that is present in an area that may be specified as the path,
wherein the safety level is determined based on the control value, the information on the center of gravity of the object, and the information on the obstacle.

### Supplementary Note 15

The path specification method according to Supplementary Note 13, wherein the safety level is determined based on the control value, the information on the center of gravity of the object, and information on a combined center of gravity of the mobile body and the object.

### Supplementary Note 16

The path specification method according to any one of Supplementary Notes 13 to 15, comprising:
performing control for adjusting a position of the mobile body where the object is loaded based on the information on the combined center of gravity of the mobile body and the object,
wherein the specifying the path is specifying the path in accordance with the safety level of a result of performing the control for the adjustment.

### Supplementary Note 17

The path specification method according to any one of Supplementary Notes 13 to 16, comprising:
generating a temporary path in accordance with map information including a range in which the mobile body may move;
calculating the control value for enabling the mobile body to travel along the generated temporary path;
performing at least one of processing for calculating a force applied to the center of gravity of the object in accordance with the calculated control value and the information on the center of gravity of the object or processing for calculating a force applied to the combined center of gravity of the mobile body and the object in accordance with the calculated control value and the information on the combined center of gravity of the mobile body and the object; and
determining the safety level in accordance with the calculated force,
wherein the specifying the path is specifying the path based on the determined safety level and the generated temporary path.

### Supplementary Note 18

The path specification method according to any one of Supplementary Notes 13 to 16, comprising:
calculating an acceptable range of the control value based on at least one of the information on the center of gravity of the object or the information on the combined center of gravity of the mobile body and the object;
generating a temporary path in accordance with the map information including the range in which the mobile body may move; and
specifying the control value for enabling the mobile body to move along the generated temporary path in accordance with the calculated acceptable range,
wherein the specifying the path is specifying the path in accordance with a safety level in conveying the object in the mobile body determined based on the specified control value and the generated temporary path.

### Supplementary Note 19

A program for causing a computer to execute path specification processing comprising:
acquiring information on a center of gravity of an object loaded on a mobile body; and
specifying a path to a place where the object is unloaded in accordance with a safety level in conveying the object in the mobile body determined based on a control value for controlling the mobile body and information on the center of gravity of the object.

### Supplementary Note 20

The program according to Supplementary Note 19, wherein
the path specification processing comprises acquiring information on an obstacle that is present in an area that may be specified as the path,
wherein the safety level is determined based on the control value, the information on the center of gravity of the object, and the information on the obstacle.

### Supplementary Note 21

The program according to Supplementary Note 19, wherein the safety level is determined based on the control value, the information on the center of gravity of the object, and information on a combined center of gravity of the mobile body and the object.

### Supplementary Note 22

The program according to any one of Supplementary Notes 19 to 21, wherein
the path specification processing comprises performing control for adjusting a position of the mobile body where the object is loaded based on the information on the combined center of gravity of the mobile body and the object, and
the specifying is specifying the path in accordance with the safety level of a result of performing the control for the adjustment.

### Supplementary Note 23

The program according to any one of Supplementary Notes 19 to 22, wherein
the path specification processing comprises:
generating a temporary path in accordance with map information including a range in which the mobile body may move;
calculating the control value for enabling the mobile body to travel along the generated temporary path;
performing at least one of processing for calculating a force applied to the center of gravity of the object in accordance with the calculated control value and the information on the center of gravity of the object or processing for calculating a force applied to the combined center of gravity of the mobile body and the object in accordance with the calculated control value and the information on the combined center of gravity of the mobile body and the object; and
determining the safety level in accordance with the calculated force,
wherein the specifying the path is specifying the path based on the determined safety level and the generated temporary path.

### Supplementary Note 24

The program according to any one of Supplementary Notes 19 to 22, wherein
the path specification processing comprises:
calculating an acceptable range of the control value based on at least one of the information on the center of gravity of the object or the information on the combined center of gravity of the mobile body and the object;
generating a temporary path in accordance with map information including a range in which the mobile body may move; and
specifying the control value for enabling the mobile body to move along the generated temporary path in accordance with the calculated acceptable range,
wherein the specifying the path is specifying the path in accordance with a safety level in conveying the object in the mobile body determined based on the specified control value and the generated temporary path.

### REFERENCE SIGNS LIST

Ca: CARGO
Cp: CARGO LOADING PALLET
Csb: UPPER SURFACE OF LOWER FRAME
Csu: LOWER SURFACE OF UPPER FRAME
R, Raa: FORKLIFT
Ra: LIFT PORTION
Rb: FORK
Rs: LOADING SURFACE
1, 100, 100a: PATH SPECIFICATION SYSTEM
1a: ACQUISITION UNIT
1b, 11b, 21b: SPECIFICATION UNIT
2: PATH SPECIFICATION APPARATUS
11, 21: CONTROL UNIT
11a, 21a: OBJECT INFORMATION ACQUISITION UNIT
11c, 21c: OBSTACLE INFORMATION ACQUISITION UNIT
11d, 21d: MOVEMENT CONTROL UNIT
11e, 21e: FORK MOTION CONTROL UNIT
12, 22, 32: COMMUNICATION UNIT
13: WHEEL DRIVE UNIT
14: FORK DRIVE UNIT
15: WEIGHT SENSOR
16: OPERATION UNIT
20, 20a: REMOTE CONTROL APPARATUS
23: DISPLAY UNIT
24: OPERATION INPUT UNIT
30: CAMERA
31: SENSOR
500: APPARATUS
510: CPU
520: STORAGE UNIT
530: ROM
540: RAM
550: COMMUNICATION INTERFACE
560: USER INTERFACE

What is claimed is:

1. A path specification system comprising:
at least one memory storing instructions; and
at least one processor configured to execute the instructions to do path specification process, wherein the path specification process includes:
acquiring information on a center of gravity of an object loaded on a mobile body; and
specifying a path to a place where the object is unloaded in accordance with a safety level in conveying the object in the mobile body determined based on a control value for controlling the mobile body and information on the center of gravity of the object.

2. The path specification system according to claim 1, wherein
the path specification process further includes acquiring information on an obstacle that is present in an area that may be specified as the path, and
the safety level is determined based on the control value, the information on the center of gravity of the object, and the information on the obstacle.

3. The path specification system according to claim 1, wherein the safety level is determined based on the control value, the information on the center of gravity of the object, and information on a combined center of gravity of the mobile body and the object.

4. The path specification system according to claim 1, wherein
the path specification process further includes performing control for adjusting a position of the mobile body where the object is loaded based on the information on the combined center of gravity of the mobile body and the object, and
the specifying the path is specifying the path in accordance with the safety level of a result of performing the control for the adjustment.

5. The path specification system according to claim 1, the path specification process further includes:
generating a temporary path in accordance with map information including a range in which the mobile body may move;
calculating the control value for enabling the mobile body to travel along the generated temporary path;
performing at least one of processing for calculating a force applied to the center of gravity of the object in accordance with the calculated control value and the information on the center of gravity of the object or processing for calculating a force applied to the combined center of gravity of the mobile body and the object in accordance with the calculated control value and the information on the combined center of gravity of the mobile body and the object; and
determining the safety level in accordance with the calculated force,
wherein the specifying the path is specifying the path based on the determined safety level and the generated temporary path.

6. The path specification system according to claim 1, the path specification process further includes:
calculating an acceptable range of the control value based on at least one of the information on the center of gravity of the object or the information on the combined center of gravity of the mobile body and the object;
generating a temporary path in accordance with map information including a range in which the mobile body may move; and
specifying the control value for enabling the mobile body to move along the generated temporary path in accordance with the calculated acceptable range,
wherein the specifying the path is specifying the path in accordance with a safety level in conveying the object in the mobile body determined based on the specified control value and the generated temporary path.

7. A path specification apparatus comprising:
at least one memory storing instructions; and
at least one processor configured to execute the instructions to do path specification process, wherein the path specification process includes:
acquiring information on a center of gravity of an object loaded on a mobile body; and
specifying a path to a place where the object is unloaded in accordance with a safety level in conveying the object in the mobile body determined based on a control value for controlling the mobile body and information on the center of gravity of the object.

8. The path specification apparatus according to claim 7, wherein:
the path specification process further includes acquiring information on an obstacle that is present in an area that may be specified as the path, and
the safety level is determined based on the control value, the information on the center of gravity of the object, and the information on the obstacle.

9. The path specification apparatus according to claim 7, wherein the safety level is determined based on the control value, the information on the center of gravity of the object, and information on a combined center of gravity of the mobile body and the object.

10. The path specification apparatus according to claim 7, wherein
the path specification process further includes performing control for adjusting a position of the mobile body where the object is loaded based on the information on the combined center of gravity of the mobile body and the object, and
the specifying the path is specifying the path in accordance with the safety level of a result of performing the control for the adjustment.

11. The path specification apparatus according to claim 7, the path specification process further includes:
generating a temporary path in accordance with map information including a range in which the mobile body may move;
calculating the control value for enabling the mobile body to travel along the generated temporary path;
performing at least one of processing for calculating a force applied to the center of gravity of the object in accordance with the calculated control value and the information on the center of gravity of the object or processing for calculating a force applied to the combined center of gravity of the mobile body and the object in accordance with the calculated control value and the information on the combined center of gravity of the mobile body and the object; and
determining the safety level in accordance with the calculated force,
wherein the specifying the path is specifying the path based on the determined safety level and the generated temporary path.

12. The path specification apparatus according to claim 7, the path specification process further includes:
calculating an acceptable range of the control value based on at least one of the information on the center of gravity of the object or the information on the combined center of gravity of the mobile body and the object;
generating a temporary path in accordance with map information including a range in which the mobile body may move; and
specifying the control value for enabling the mobile body to move along the generated temporary path in accordance with the calculated acceptable range,
wherein the specifying the path is specifying the path in accordance with a safety level in conveying the object in the mobile body determined based on the specified control value and the generated temporary path.

13. A path specification method comprising:
acquiring information on a center of gravity of an object loaded on a mobile body; and
specifying a path to a place where the object is unloaded in accordance with a safety level in conveying the object in the mobile body determined based on a control value for controlling the mobile body and information on the center of gravity of the object.

14. The path specification method according to claim 13, further comprising:
acquiring information on an obstacle that is present in an area that may be specified as the path,
wherein the safety level is determined based on the control value, the information on the center of gravity of the object, and the information on the obstacle.

15. The path specification method according to claim 13, wherein the safety level is determined based on the control value, the information on the center of gravity of the object, and information on a combined center of gravity of the mobile body and the object.

16. The path specification method according to claim 13, further comprising:
performing control for adjusting a position of the mobile body where the object is loaded based on the information on the combined center of gravity of the mobile body and the object,
wherein the specifying the path is specifying the path in accordance with the safety level of a result of performing the control for the adjustment.

17. The path specification method according to claim 13, further comprising:
generating a temporary path in accordance with map information including a range in which the mobile body may move;
calculating the control value for enabling the mobile body to travel along the generated temporary path;
performing at least one of processing for calculating a force applied to the center of gravity of the object in accordance with the calculated control value and the information on the center of gravity of the object or processing for calculating a force applied to the combined center of gravity of the mobile body and the object in accordance with the calculated control value and the information on the combined center of gravity of the mobile body and the object; and
determining the safety level in accordance with the calculated force,
wherein the specifying the path is specifying the path based on the determined safety level and the generated temporary path.

18. The path specification method according to claim 13, further comprising:
calculating an acceptable range of the control value based on at least one of the information on the center of gravity of the object or the information on the combined center of gravity of the mobile body and the object;
generating a temporary path in accordance with map information including a range in which the mobile body may move; and
specifying the control value for enabling the mobile body to move along the generated temporary path in accordance with the calculated acceptable range,
wherein the specifying the path is specifying the path in accordance with a safety level in conveying the object in the mobile body determined based on the specified control value and the generated temporary path.
